(19) United States
(12) Patent Application Publication
(10) Pub. No.: US 2005/0092198 A1
(43) Pub. Date: May 5, 2005

(54) Printing plate, fabricating method thereof, method of making a printing plate with a print image, method of reproducing the printing plate with a print image, and printing press

(76) Inventors: Fumihiko Hirose, Yamagata-ken (JP); Satoshi Sakai, Kanagawa-ken (JP); Hiroshi Tonegawa, Kanagawa-ken (JP); Yasuharu Suda, Hiroshima-ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/965,801

(22) Filed: Oct. 18, 2004

(30) Foreign Application Priority Data
Nov. 5, 2003 (JP) 2003-376158

(51) Int. Cl. B41N 1/00

(52) U.S. Cl. 101/395

(57) ABSTRACT

It is the primary object of the present invention to provide a printing plate, a fabricating method thereof, a method of making a printing plate with a print image, a method of reproducing the printing plate with a print image, and a printing press that are capable of reducing the light irradiation energy required for writing an image when making a printing plate and erasing the image when reproducing the printing plate.

A printing plate including a photocatalyst layer. The photocatalyst layer contains a photocatalyst TiO₂ or a TiO₂ compound in a surface thereof. The volume rate of an anatase-type crystal in the total crystal component of the photocatalyst TiO₂ or TiO₂ compound is between 0.4 and 1.0. The total volume crystallization ratio of the photocatalyst is 20% or greater.

### BACKGROUND OF THE INVENTION

1) Field of the Invention

The present invention relates to a printing plate containing a photocatalyst layer, a fabricating method thereof, a method of making a printing plate with a print image, a method of reproducing the printing plate with a print image, and a printing press.

2) Description of the Related Art

Offset printing is widely used because the plate-making step is simple. In this printing technique, hydrophobic regions to which ink adheres (printing portions), and hydrophilic regions in which dampening water is held (non-printing portions), are formed on the surface of a printing plate in dependence on information on an image to be printed. And printing is performed by causing printing paper to contact directly with the printing plate, or by causing printing paper to contact indirectly with the plate through a blanket cylinder. The printing plate is also simply called a “plate” and an image (also called a print image) to be printed on paper is formed on printing plate.

In offset printing press practically being used, an image is written to a new plate, and after the printing is used once in printing as a printing plate, the printing plate is discarded. Therefore, a repeatedly usable plate and a printing press capable of using that plate, in addition to having the indirect advantage that they save resources and are environment-friendly, have the direct advantage that users can reduce printing costs. For that reason, various investigations and experiments have been made. The “repeatedly usable” system used herein is intended to mean a system relating to a printing press where an image is written with a plate being installed in the press, or an image already written to a plate is erased and then a new image is written again to the plate. That is, the “repeatedly usable” system is different from conventional printing press where a printing plate with an image written by a dedicated plate-making device is installed and then printing is performed. There is another system in which (1) a printing plate with an image written by a plate-making machine is installed, (2) printing is performed, (3) the printing plate is removed and processed so that it can be repeatedly used, and (4) the processed printing plate is installed again. However, time-consuming efforts to remove and install the printing plate often counterbalance the advantage of cost reduction obtained by repeatedly using the printing plate.

Recently, there has been proposed a system in which a photocatalyst is used in a printing that is repeatedly usable while being installed in a printing press. This system is a system where a photocatalyst layer containing a photocatalyst e.g. titanium oxide is formed on a surface of a printing plate, and is being expected as the next-generation printing method. The system is disclosed in Japanese Laid-Open Patent Publication Nos. Hei 10-250027, 2000-131827, Hei 11-249287, Hei 11-305422, and 2000-62335, although details are different. The system is characterized in that the property of making the photocatalyst layer of a printing plate hydrophilic when irradiated with light of photon energy higher than bandgap energy is utilized as non-printing portions on the printing plate. To form hydrophobic printing portions in a printing plate, the surface of the printing plate must be made hydrophobic. In a typical method of making the surface hydrophobic, as described in Japanese Laid-Open Patent Publication Nos. 2000-62335 and 2000-203144, an organic compound with a hydrophobic radical is caused to bond or adhere to the surface of a photocatalyst to form a hydrophobic surface.

A problem with the above-described system is to remove the ink and dampening water remaining on a printing plate after printing, and to remove an organic compound forming printing portions and erase the image history.

In a typical method for removing ink, ink is removed by a cleaning unit, etc. More specifically, a solvent for removing ink is brought into contact with a printing plate by some method so that ink is dissolved in this solvent. Or the printing plate is wiped or rubbed with cloth containing a solvent. Also, removal of an organic compound is performed by dissolving the organic compound in a solvent having ability to dissolve organic compounds.

However, in the methods employing a solvent, if ink, etc., are to be removed almost completely, a large amount of solvent must be used and therefore costs are increased. In addition, removing ink almost completely is time-consuming. Furthermore, solvents have to be processed as waste fluid. That is, ink, etc., can be removed to the degree that is clean to look at, but it is practically difficult to remove ink, etc., almost completely, that is, to remove them in a molecular level. For instance, removing ink with a solvent can conversely mean that ink is stained with a solvent. Therefore, if a printing plate is cleaned with a solvent in which ink is dissolved, a very thin film of nonvolatile substance will remain on the printing plate as a stain, after the solvent is dried. To overcome this problem, a cleaning step must be repeated the required number of times with a new solvent. In such a chemically removing method, an evil influence in the case of imperfect removal of ink, etc., is described, for example, in the aforementioned Japanese Laid-Open Patent Publication No. 2000-131827. In this publication, when a new image is written to a printing plate on which a cleaning step has been performed, and printing is performed with the cleaned printing plate, the frequency of ink stains on printing paper is increased compared to a new printing plate. As the reason for that, it is stated that the cleaning of ink is imperfect. That is, hydrophilic portions obtained by irradiating light to a photocatalyst surface are utilized as non-printing portions, but when there are stains such as ink, binders in ink are high polymers and difficult to dissolve, so that they keep a printing plate from being made hydrophilic. Therefore, regions that are originally non-printing portions are not sufficiently made hydrophilic, so some of the regions remain hydrophobic. Because of this, ink adheres to the hydrophobic regions and appears as an ink stain on printing paper.

Besides the above-described chemical removal methods, there is a method of irradiating light to a photocatalyst film and removing the ink and organic compound forming printing portions on a printing plate by photocatalytic action. This method can eliminate the waste fluid process that becomes a problem in the above-described chemical removal methods, but when complete removal is performed, light of wavelengths greater than the forbidden gap or bandgap energy of a photocatalyst is required. For instance, when a photocatalyst is titanium dioxide (TiO₂), a light source of high brightness for irradiating light of wavelengths less than 380 nm is required. In addition, to remove residues sufficiently, energy irradiation greater than tens of joules per 1 cm becomes necessary, depending on the surface density of residues. As a result, the image erasing device becomes bulky and the device cost is increased. The light with wavelengths greater than the bandgap energy of a photocatalyst will hereinafter be referred to as activation light.

Although a description has been given of the problems with methods that remove the residues after printing such as ink, dampening water, and an organic compound forming printing portions, activation light must be irradiated in order to form printing portions and non-printing portion in a printing plate when making the plate, that is, write an image to the printing plate. That is, in writing an image to a printing plate, activation light irradiation at strong illuminance is required the same as when residues are removed. For that reason, the writing device becomes bulky and the device cost is increased.

### SUMMARY OF THE INVENTION

The present invention has been made in view of the problems found in prior art. Accordingly, it is the primary object of the present invention to provide a printing plate, a fabricating method thereof, a method of making a printing plate with a print image, a method of reproducing the printing plate with a print image, and a printing press that are capable of reducing the light irradiation energy required for writing an image when making a printing plate and erasing the image when reproducing the printing plate.

To achieve this end, there is provided a printing plate including a photocatalyst layer. The photocatalyst layer contains a photocatalyst TiO₂ or a TiO₂ compound in a surface thereof. The volume rate Rₐ of an anatase-type crystal in the total crystal component of the photocatalyst TiO₂ or TiO₂ compound is between 0.4 and 1.0 (0.4≦Ra≦1.0). The total volume crystallization ratio of the photocatalyst is 20% or greater. It is preferable that Ra be closer to 1.0. It is preferable that the total crystallization ratio of the photocatalyst be 50% or greater and further preferable that it be 70% or greater. If the volume rate of an anatase type crystal and the total volume crystallization ratio of the photocatalyst are in the above-described ranges, the performance of the photocatalyst can be enhanced. According to this, the light irradiation energy required for writing an image when making a printing plate and erasing the image when reproducing the printing plate can be reduced. This can prevent the image writing device and image erasing device from becoming bulky, so it becomes possible to suppress device costs.

Also, it is preferable that in X-ray diffraction, the photocatalyst layer show at least one of the diffraction intensities in the <101>, <200>, <004>, <112>, <211>, and <220> plane-directions of an anatase type.

Preferably, the aforementioned photocatalyst layer is formed on a metal substrate or a polymer substrate. According to this, the printing plate is flexible, so it becomes easy to attach in wrapping around a printing plate. In addition, in the case of a polymer substrate, the weight is reduced and therefore it becomes easy to handle.

It is preferable that the metal substrate be any one of stainless, Ti, and Al plates. According to this, the mechanical durability of the printing plate can be assured.

Preferably, the aforementioned photocatalyst layer is a multilayered film in which the composition or volume crystallization ratios are different. According to this, the performance of the photocatalyst can be enhanced. For example, if the photocatalyst layer is formed into a multilayered film by forming on a TiO₂ film capable of obtaining a high crystallization ratio a TiO₂ compound doped with metal ions or negative ions so as to have a new function, the performance of the photocatalyst layer can be enhanced.

Also, the aforementioned photocatalyst layer may be a gradient film in which the composition or volume crystallization ratio varies continuously in the direction of the film thickness. According to this, the performance of the photocatalyst can be enhanced. For instance, if the photocatalyst layer is formed into a gradient film in which the composition or crystallization ratio varies continuously from a TiO₂ film capable of obtaining a high crystallization ratio to a TiO₂ compound doped with metal ions or negative ions so as to have a new function, the performance of the photocatalyst layer can be enhanced.

It is preferable that the aforementioned photocatalyst TiO₂ or TiO₂ compound be a photocatalyst that responds to light having a wavelength of less than visible light. That is, it is preferable that it be a photocatalyst that responds not only ultraviolet light but also the light in a visible light region (i.e., light of the wavelength range from near-ultraviolet to near-infrared). By employing a photocatalyst that responds to visible light, it becomes possible to write an image to a printing plate with visible light. This makes it possible to use a light source inexpensive compared to an ultraviolet light source, so it becomes possible to reduce writing-device costs.

Preferably, at least either an intervening layer consisting of SiO₂ or an intervening layer consisting of a silica titania (SiO₂—TiO₂) solid acid catalyst is formed on the substrate, and the photocatalyst layer is formed on the intervening layer. According to this, the intervening layer prevents the crystal type of a photocatalyst and crystal quantity from being influenced by the type of substrate used, and the function of the photocatalyst layer can be enhanced. Thus, it is possible to stabilize the performance of the photocatalyst layer and to enhance the performance.

To achieve the aforementioned object of the present invention, there is provided a method of fabricating the aforementioned printing plate. The method includes the step of forming the photocatalyst layer by chemical vapor deposition. If the aforementioned photocatalyst layer is formed by chemical vapor deposition, crystallization of a photocatalyst occurs easily and the volume rate of an anatase type crystal and the total volume crystallization ratio of the photocatalyst are in the above-described ranges, so it becomes easy to enhance the performance of the photocatalyst. This makes it possible to enhance the photocatalytic action of the photocatalyst layer to a sufficient level as a reproducible plate. That is, it is possible to write and erase an image with low light irradiation, that is, in a short time. Note that when the photocatalyst layer can develop a sufficient function as a plate without an intervening layer, it may be omitted.

To achieve the aforementioned object of the present invention, there is also provided a method of fabricating the aforementioned printing plate. The method includes the step of forming the intervening layer on the substrate and the step of forming the photocatalyst layer on the intervening layer by chemical vapor deposition, after the intervening layer is formed. The intervening layer prevents the crystal type of a photocatalyst and crystal quantity from being influenced by the type of substrate used, and the function of the photocatalyst layer can be enhanced. Since the fabricating method has the step forming the photocatalyst layer on the intervening layer by chemical vapor deposition, crystallization of a photocatalyst occurs easily and the volume rate of an anatase type crystal and the total volume crystallization ratio of the photocatalyst are in the above-described ranges, so it becomes easy to enhance the performance of the photocatalyst. The combination of the intervening-layer forming step and the photocatalyst-layer forming step makes it possible to enhance the photocatalytic action of the photocatalyst layer to a sufficient level as a reproducible plate. That is, it is possible to write and erase an image with lower light irradiation, that is, in a shorter time.

It is preferable that after the photocatalyst layer is formed, a heating process be performed at about 400 to 800° C. If a heating process is performed at the aforementioned temperature range, the volume rate Rₐ of an anatase type crystal to the total crystal component of the photocatalyst layer is easily caused to be in the aforementioned range. In addition, lattice defects and other defects are reduced and crystal quality becomes higher, so the performance of the photocatalyst layer is enhanced. That is, it becomes possible to reduce the light irradiation energy required to write and erase an image. This can prevent the image writing device and image erasing device from becoming bulky, so it becomes possible to suppress device costs.

To achieve the aforementioned object of the present invention, there is also provided a method of making a printing plate by using the aforementioned printing plate. The method includes the step of making a surface of the photocatalyst layer hydrophobic, and the step of irradiating activation light having energy higher than the bandgap energy of the photocatalyst to at least a portion of the hydrophobic surface of the photocatalyst layer to write an image to the hydrophobic surface of the photocatalyst layer. According to this, activation light is irradiated to the hydrophobic surface of the photocatalyst layer in dependence on image data, and the hydrophobic surface can be converted to a hydrophilic surface by photocatalytic action. In this way, hydrophilic non-printing portions and hydrophobic printing portions are formed, so a printing plate can be made without a developing process. Therefore, the time to make a printing plate can be shorted because the developing step indispensable for the conventional plate-making step employing a PS plate or CTP plate is omitted. In addition, the plate making method of the present invention does not require an alkali developing solution that must be processed as an industrial waste after use, so it is environment-friendly.

It is preferable that the surface of the photocatalyst layer be made hydrophobic by supplying a hydrophobic organic compound to the surface of the photocatalyst layer. According to this, by irradiating activation light to the surface of the photocatalyst layer made hydrophobic with an organic compound, the organic compound of the light-irradiated portion can be resolved into a hydrophilic surface. In this way, hydrophilic non-printing portions and hydrophobic printing portions are formed, whereby a printing plate can be made.

To achieve the aforementioned object of the present invention, there is also provided a method of reproducing a printing plate by using the aforementioned printing plate. The reproducing method comprises the step of removing ink adhering to a surface of the photocatalyst layer, and the step of irradiating activation light having energy higher than the bandgap energy of the photocatalyst to the entire surface of the photocatalyst layer to make the surface of the photocatalyst layer hydrophilic. According to this, ink containing polymer binders is first removed and then activation light is irradiated to the entire photocatalyst layer. This can reduce the irradiation energy of activation light required for image erasure. Thus, it is possible to shorten the time to erase an image.

It is preferable that the surface of the photocatalyst layer be heated at the same time as when activation light is irradiated to the surface of the photocatalyst layer. If activation light is irradiated while heating the printing plate, the oxidative resolution of an organic compound that is caused by photocatalytic action is accelerated and therefore it becomes possible to erase an image history with less activation light irradiation, i.e., in a shorter time. This is based on the assumption that the diffusion speed of an OH radical that is caused under activation light irradiation by photocatalytic action becomes faster by heating and the OH radial is more effectively utilized in the oxidative resolution of an organic compound. Furthermore, it is preferable that the temperature at which the surface of the photocatalyst layer is heated be 100° C. or greater. According to this, the oxidative resolution of the photocatalyst layer can be accelerated.

To achieve the aforementioned object of the present invention, there is also provided a printing press, which comprises a plate cylinder to which the aforementioned printing plate is attached; a unit for making a surface of a photocatalyst layer of the printing plate hydrophobic; an image writing unit for irradiating activation light having energy higher than the bandgap energy of the photocatalyst to at least a portion of the hydrophobic surface of the photocatalyst layer to write an image to the hydrophobic surface of the photocatalyst layer; a cleaning unit for removing ink adhering to the surface of the photocatalyst layer after printing; and an image erasing unit for erasing the image by irradiating the activation light to the entire surface of the photocatalyst layer after removal of the ink to make the surface of the photocatalyst layer hydrophilic. According to this, it is possible to continuously perform on the printing press the step of writing an image in dependence on digital data when making a printing plate, the step of erasing an image history after printing, and the step of initializing the printing plate to make the entire printing plate hydrophobic. Therefore, digitalization of the printing step becomes possible, and the management of a printing factory by digital data becomes easier. Since the printing plate can be reproduced for reuse, the cost of the printing plate can be reduced. Particularly, the cost of the printing plate in small-lot printing can be reduced. Furthermore, if the aforementioned photocatalyst TiO₂ or TiO₂ compound is also sensitive to light having wavelengths of less than visible light, inexpensive light sources for emitting light in a visible region can be used and therefore the cost of the writing unit can be reduced.

### BRIEF DESCRIPTION OF THE DRAWINGS

The present invention will be described in further detail with reference to the accompanying drawings wherein:

FIG. 1 is a simplified sectional view showing the case where a printing plate constructed in accordance with a preferred embodiment of the present invention is hydrophobic;

FIG. 2 is a simplified sectional view showing the case where the printing plate is hydrophilic;

FIG. 3 is a conceptual diagram showing how plate making and reproduction are performed by employing the printing plate constructed in accordance with the preferred embodiment of the present invention;

FIG. 4 is a perspective view showing a printing plate constructed in accordance with the preferred embodiment of the present invention;

FIG. 5 is a timing diagram showing the relationship between the contact angle of water with the surface of the printing plate and time (or manipulation); and

FIG. 6 is a schematic diagram showing a printing press that performs printing by employing the printing plate constructed in accordance with the preferred embodiment, and also performs plate reproduction.

### DESCRIPTION OF THE PREFERRED EMBODIMENTS

Embodiments of the present invention will hereinafter be described in detail with reference to the drawings.

(A) Construction of a Printing Plate

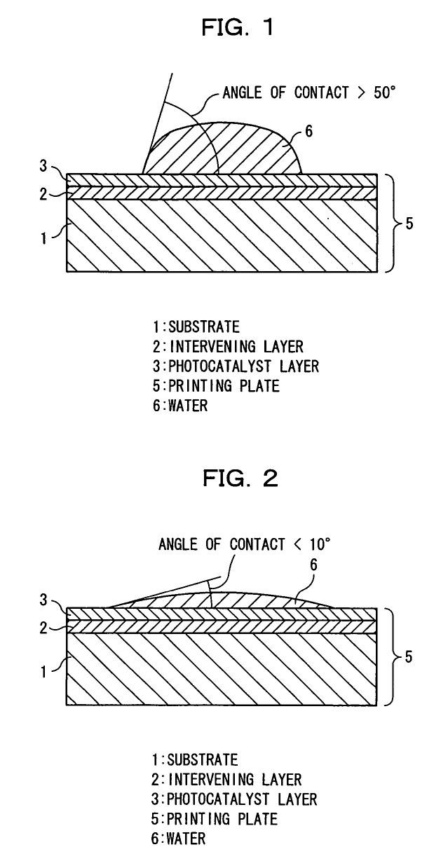

Referring to FIGS. 1 and 2, there is shown a printing plate constructed in accordance with a preferred embodiment of the present invention. FIG. 1 is a sectional view showing the case where the plate surface (surface of the planographic printing plate) is hydrophobic, while FIG. 2 is a sectional view showing the case where the plate surface is hydrophilic. The printing plate is also simply called a “plate” and an image (also called a print image) to be printed on paper is formed on printing plate.

As shown in FIG. 1, the printing plate 5 according to this embodiment consists basically of a substrate 1 (or base), an intervening layer 2, and a photocatalyst-containing layer 3 (hereinafter referred to as a photocatalyst layer).

The substrate 1 is formed from a metal substrate or polymer substrate. If it is formed from a metal substrate, the mechanical durability of the plate 5 can be assured. In this case, the plate 5 is used in contact with an aqueous solution such as dampening water, so a material that resists rust in addition to the above-described mechanical durability is preferable. Preferred examples are stainless plate, titanium (Ti) plate, aluminum (Al) plate, etc. In the case where the substrate 1 is formed from a polymer substrate, it becomes easier to handle because its weight is reduced.

The intervening layer 2 is sandwiched between the substrate 1 and the photocatalyst layer 3. It is preferable that the intervening layer 2 be formed from at least either a silica film consisting of SiO₂ or a film consisting of a silica titania (SiO₂—TiO₂) solid acid catalyst. If the intervening layer 2 is formed between the substrate 1 and the photocatalyst layer 3, the influence of the crystal structure of a photocatalyst by the type of substrate used can be prevented and the performance of the photocatalyst layer 3 can be enhanced. Thus, it becomes possible to stabilize and enhance the performance of the photocatalyst layer 3. For example, when the photocatalyst layer 3 is formed directly on the metal substrate 1, the metal atoms contained in the substrate 1 are diffused into the photocatalyst layer 3 and act as impurities against the photocatalyst layer 3, so that they suppress the performance of a photocatalyst. However, if a silica film intervenes between them, the metal atoms contained in the substrate 1 are prevented from being diffused into the photocatalyst layer 3. In addition, since a silica film is apt to absorb water, the absorbed water molecule will react with electrons and holes generated at the time of light irradiation and change into a radical type such as a single atom oxygen and OH. This accelerates the resolution of an organic compound (hydrophobic compound) that is a hydrophobic agent. This makes it possible to remove the organic compound on the surface with less light irradiation energy. In addition, an acid point that a silica titania film with SiO₂ and TiO₂ at a volume ratio of 1:1 has is assumed to activate photocatalytic operation, and accelerates the resolution reaction of the organic compound of a photocatalyst. Of course the volume ratio of SiO₂ and TiO₂ is not limited to 1:1.

The photocatalyst layer 3 is a film containing TiO₂ (titanium dioxide photocatalyst) or a TiO₂ compound (titanium dioxide photocatalyst compound). It is preferable that a TiO₂ compound be TiO₂ doped with SiO₂, Sr, N, and S. If the photocatalyst layer 3 is irradiated with light (active light) greater than the forbidden gap or bandgap energy of a photocatalyst, electron-hole pairs are created within the film, cause diffusion on the surface, and cause an oxidation-reduction reaction. For instance, when organic compounds are caused to adhere on the surface of the photocatalyst layer 3, many of the organic compounds are hydrophobic to water, but if this surface is irradiated with light, the organic compounds on the surface are oxidized and resolved and are removed. This makes it possible to make only light-irradiated portions hydrophilic. Therefore, if a hydrophobic organic compound is coated uniformly on the plate surface (i.e., the surface of the photocatalyst layer 3), and only portions corresponding to printing-portions are made hydrophilic by light irradiation, hydrophobic portions to which ink adheres (printing portions) and hydrophilic portions to which dampening water adheres (non-printing portions) are formed, so that an image can be written to the plate (photocatalyst layer 3). When reproducing the plate, all of the residues on the plate surface can be removed by irradiating light to the entire plate surface.

Note that TiO₂ or a TiO₂ compound, which develops photocatalyst activity in response to not only ultraviolet light but also the light in a visible light region (i.e., light of the wavelength range from near-ultraviolet to near-infrared), may be employed. If a photocatalyst (visible light response type catalyst) that responds to light in the visible light region is employed, it becomes possible to write an image to the plate 5 with visible light. This makes it possible to use light sources cheaper than ultraviolet sources, so the cost of the writing device can be reduced.

It is desirable that the photocatalyst layer 3 be crystalline. For example, when the photocatalyst layer 3 is noncrystalline like an amorphous substance, absorption of light reduces the diffusion coefficient of an electron-hole pair, so that the speed at which the organic compound on the surface is resolved by light irradiation becomes slower.

TABLE 1

| Volume crystallization | Light irradiation |
|---|---|
| ratio | energy |
| 5% | — |
| 10% | — |
| 20% | 20 J/cm² |
| 30% | 15 J/cm² |
| 50% | 3 J/cm² |
| 70% | 2 J/cm² |

Table 1 shows the relationship between the volume crystallization ratio and the light irradiation energy required for resolution of an organic compound, when the photocatalyst layer 3 consisting of TiO₂ is caused to adsorb an organic compound system corresponding to the amount of one molecular layer and is irradiated with light of wavelength 365 nm. For resolution of the organic compound, the completion of resolution was judged by the change of the TiO₂ surface from a hydrophobic state to a hydrophilic state. As listed in Table 1, when the volume crystallization ratio is 5% and 10%, there is no hydrophilic phenomenon and therefore there is no resolution of an organic compound. However, when the volume crystallization ratio is 20% or greater, resolution of an organic compound takes place. In addition, it has been found that if the volume crystallization ratio becomes higher, an organic compound can be resolved with less light irradiation energy. The light irradiation energy at the volume crystallization ratios of 20%, 30%, 50%, and 70% was 20 J/cm², 15 J/cm², 3 J/cm², and 2 J/cm², respectively.

TABLE 2

| Rate of anatase-type | Light irradiation |
|---|---|
| titanium dioxide | energy |
| 0 | — |
| 0.35 | — |
| 0.4 | 22 J/cm² |
| 0.6 | 15 J/cm² |
| 1.0 | 4 J/cm² |

Table 2 shows the relationship between the rate of an anatase-type crystal to the crystal of TiO₂ having a volume crystallization ratio of about 30% and the light irradiation energy required for resolution of an organic compound. As listed in Table 2, when the rate of anatase-type titanium dioxide is 0 and 0.35, there is no hydrophilic phenomenon and therefore there is no resolution of an organic compound. However, when the rate is 0.4 or greater, resolution of an organic compound takes place. In addition, it has been found that if the rate of an anatase type becomes higher, an organic compound can be resolved with less light irradiation energy (i.e., with high sensitivity). When the rates of an anatase type are 0.4, 0.6, and 1.0, the light irradiation energy is 22 J/cm², 15 J/cm², and 4 J/cm², respectively.

When the photocatalyst layer 3 is formed by chemical vapor deposition (CVD) or sputtering, it often contains a rutile-type crystal and an anatase-type crystal together. From the comparative experiments it has been found that the state in which the volume of the anatase-type crystal is larger than that of the rutile-type crystal is good. Particularly, the state in which the anatase-type crystal is 100% is preferred. It has also been found that in an X-ray diffraction method, if a film where the volume rate of the anatase-type crystal is higher has at least one of the intensities in the <101>, <004>, <112>, <200>, <211>, and <200> plane-directions of the anatase type, the sensitivity is comparatively higher.

The photocatalyst layer 3 may be a multilayered film in which the composition or volume crystallization ratios are different. For example, the photocatalyst layer 3 is formed into a multilayered film by forming on a TiO₂ film capable of obtaining a high crystallization ratio a TiO₂ compound doped with metal ions or negative ions (where a high crystallization ratio is normally difficult to obtain) so as to have a new function. Under the influence of the underlying TiO₂ film with a high crystallization ratio, the crystallization ratio of the TiO₂ compound film can be enhanced and the performance of the photocatalyst layer 3 can be enhanced.

The photocatalyst layer 3 may also be a gradient film in which the composition or volume crystallization ratio varies continuously in the direction of the thickness. For instance, the photocatalyst layer 3 may be formed into a gradient film where the composition or crystallization ratio varies, by forming a TiO₂ film on the intervening layer 2, and doping the TiO₂ film with metal ions or negative ions continuously toward the surface to form a TiO₂ compound film. In this way, the performance of the photocatalyst of the TiO₂ compound film can also be enhanced.

It is preferable that the photocatalyst layer 3 be formed by CVD. In typical CVD, a film is formed on a heated substrate by thermally reacting with material gases. If a substrate is heated at the time of film formation, crystallization is easily performed. Therefore, a film highly sensitive to light can be readily obtained.

(B) Making Method and Reproducing Method of Printing Plate With a Print Image

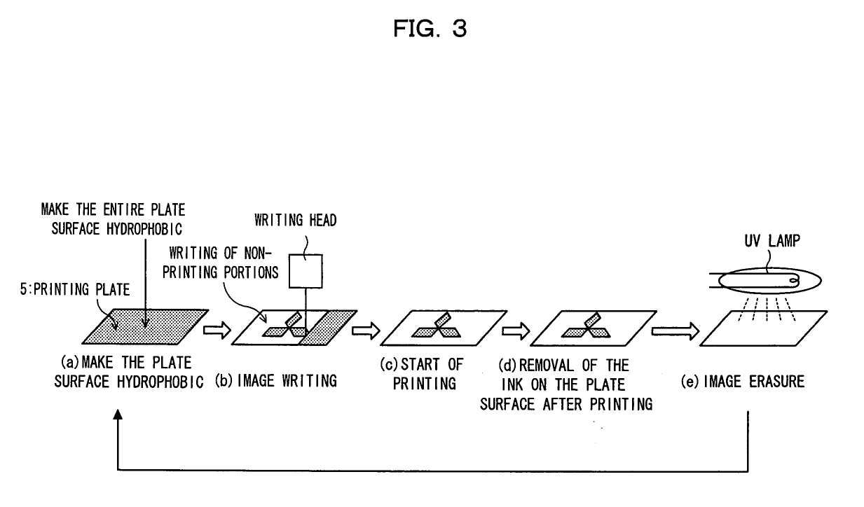

Next, a description will be given of a plate making method and plate reproducing method that employ the printing plate constructed in accordance with the preferred embodiment of the present invention. Initially, the plate making method will be described. FIG. 3 shows a conceptual diagram of plate making and reproduction. In the following description, the “plate making” is to make a plate surface hydrophobic, irradiate activation light to at least a portion of the plate surface in dependence on digital data (printing image data for an image) to form hydrophilic non-printing portions and hydrophobic printing portions, and form on the plate surface a latent image consisting of the hydrophobic printing portions and hydrophilic non-printing portions.

First, activation light (ultraviolet light) is irradiated to a printing plate so that the contact angle of water with the entire surface of the printing plate is less than 10°. As a result, a hydrophilic surface is obtained as shown in FIG. 2, and the history (image) on the printing plate is erased (see step (e) in FIG. 3). It is preferable to heat the printing plate at the same time as the irradiation of activation light. If activation light is irradiated while heating the printing plate, the oxidative resolution of an organic compound that is caused by photocatalytic action is accelerated and therefore it becomes possible to erase an image history with less activation light irradiation, i.e., in a shorter time. This is based on the assumption that the diffusion speed of an OH radical that is caused under activation light irradiation by photocatalytic action becomes faster by heating and the OH radial is more effectively utilized in the oxidative resolution of an organic compound. In addition, the acceleration of the oxidative resolution by heating is great when the temperature of the printing plate is 100° C. or greater.

Next, by supplying a hydrophobic organic compound to the printing plate, the entire printing plate is made hydrophobic. This state is shown in step (a) of FIG. 3. The hydrophobic printing plate used herein is intended to mean a printing plate where the contact angle of water is 50° or greater, preferably 80° or greater. In this state, printing oil ink (including polymer binders) adheres easily, while adhesion of dampening water is difficult.

This state of the printing plate is referred to as “the initial state at the time of plate making.” Note that the initial state at the time of plate making may be considered as the start of printing in a printing step. More specifically, the initial state indicates the state in which digital data for an image is about to be written to a printing plate.

Next, in the step of writing an image, non-printing portions are written to the above-described hydrophobic printing plate by activation light. The non-printing portions are written in dependence on the digital data of the image. The non-printing portions used herein are hydrophilic portions where the contact angle of water is less than 100 . Dampening water adheres easily to hydrophilic portions, while adhesion of printing ink is difficult.

The method of developing hydrophilic non-printing portions in dependence on image data is performed by irradiating activation light to the printing plate to make the printing plate hydrophilic by photocatalytic action. Since portions unexposed to activation light remain hydrophobic, a latent image consisting of hydrophobic printing portions and hydrophilic non-printing portions is formed on the printing plate. In this way, the printing plate is made. For example, as shown in step (b) of FIG. 3, non-printing portions are written to the hydrophobic printing plate with a writing head employing an ultraviolet light source such as a mercy lamp of wavelength 365 nm.

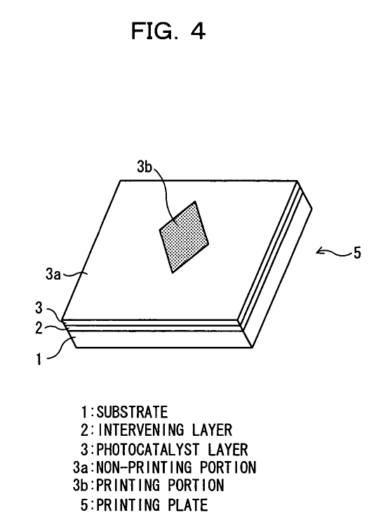

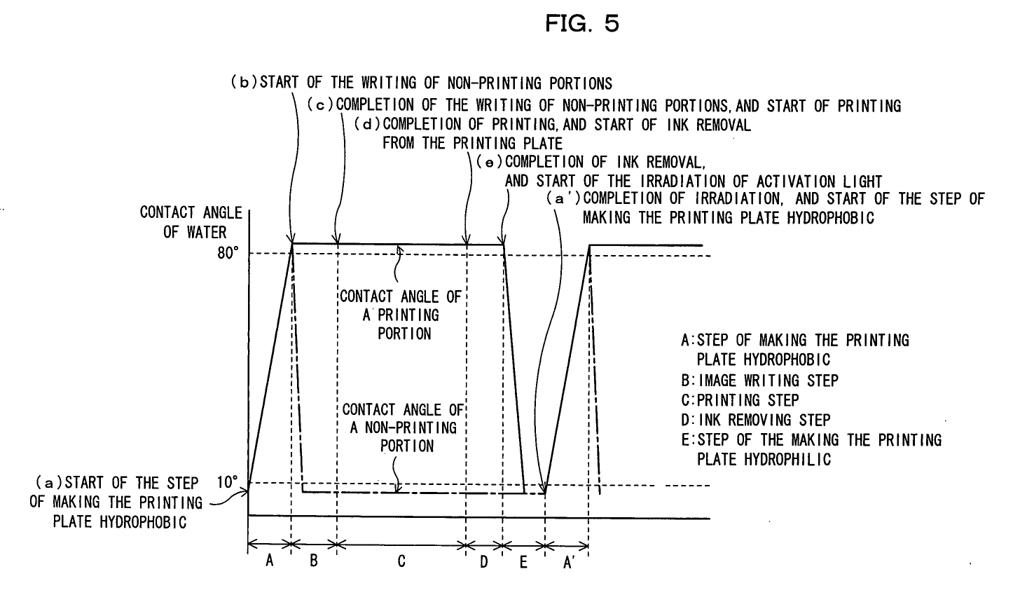

In this way, as shown in step (c) of FIG. 3, formation of printing portions and non-printing portions onto the printing plate is completed and a printable state is obtained. And dampening water and emulsified ink (where printing oil ink is mixed with dampening water) are applied to the printing plate. As a result, a plating plate such as that shown in FIG. 4 is made. In the figure, the shaded portion indicates the state in which oil ink adheres to the above-described hydrophobic printing portion 3b, while the white portion indicates the state in which dampening water adheres to the hydrophilic non-printing portion 3a, while oil ink is rejected and does not adhere to the hydrophilic non-printing portion 3a. If an image develops in this way, the plate 5 functions as a printing plate. Thereafter, a printing step is executed, and it is finished.

Next, a description will be given of the plate reproducing method. The plate reproduction is to return the printing plate to “the initial state at the time of plate making” by converting the printing plate (which has at least a hydrophilic portion) from a hydrophilic state to a hydrophobic state. That is, the initial state is obtained by making the entire surface of the printing plate hydrophilic, and then supplying a hydrophobic organic compound to the hydrophilic printing plate.

First, as shown in step (d) of FIG. 3, in ink-removing step, the ink, dampening water, and paper powder, etc., adhering to the printing plate after printing, are removed. They can be removed by employing a method of using up the ink remaining on the printing plate by stopping the supply of ink to the printing plate, a method of wiping up the ink on the printing plate with a mechanism of winding up an ink-removing cloth tape, a method of wiping up the ink on the printing plate with an ink-removing roller, a method of cleaning ink by spraying a cleaner to the printing plate, and so on.

Thereafter, activation light is irradiated while heating the entire surface of the printing plate having at least a hydrophobic portion. In this way, the printing portions are made hydrophilic. Therefore, it is possible to cause the entire printing plate to be in the state where the contact angle of water is 100 or so, that is, in the state shown in FIG. 2.

The property of converting hydrophobic printing portions on the printing plate to hydrophilic portions by irradiating activation light can be achieved by employing TiO₂ or a TiO₂ compound. In this embodiment, as shown in step (e) of FIG. 3, the hydrophobic printing portions are converted to hydrophilic portions to make the entire surface of the printing plate hydrophilic by irradiating ultraviolet light with an ultraviolet lamp. In this manner, the image history on the printing plate is erased.

Next, as shown in step (a) of FIG. 3, if an organic compound with a hydrophobic property is supplied to the printing plate recovered to the hydrophilic state by irradiation of ultraviolet light, the entire surface of the printing plate can be converted from a hydrophilic state to a hydrophobic state. Thus, it is possible to return the printing plate to the initial state at the time of plate making.

The above explanation is shown in a timing diagram of FIG. 5. In the figure, the horizontal axis represents time (or manipulation) and the vertical axis represents the contact angle of water 6 with the surface of the plate 5 (see FIGS. 1 and 2). FIG. 5 shows how the contact angle of water with the plate 5 (i.e., hydrophobic and hydrophilic states) varies with time or manipulation. In the figure, alternate long and short dash lines indicate non-printing portions, and solid lines indicate printing portions.

First, activation light is irradiated to the printing plate so that the contact angle of water 6 shows a high hydrophilic property of less than 10° (time a).

And in a step of making the printing plate hydrophobic (step A), an organic compound with a hydrophobic property is supplied to the printing plate to convert the printing plate to a hydrophilic state to a hydrophobic state. This state is the initial state at the time of plate making. In this state, the contact angle of water 6 with the surface of the printing plate is greater than 50°, preferably greater than 80°.

Next, in an image-writing step (step B), the writing of non-printing portions to the hydrophobic printing plate by activation light is started (time b). In this way, exposed portions on the printing plate are converted to hydrophilic non-printing portions by photocatalytic action. That is, the contact angle of water 6 on the printing plate becomes less than 10°. On the other hand, unexposed portions remain hydrophobic, so they become hydrophobic printing portions. Therefore, the plate 5 can function as a printing plate.

After the writing of non-printing portions is completed, printing is started (time c) in a printing step (step C). If printing is completed, the ink and stains on the printing plate are removed (timed) in an ink-removing step (step D). And after the removal of ink, the irradiation of activation light onto the printing plate is started (time e) in a step of making the printing plate hydrophilic (image-erasing step (step E)). In this way, hydrophobic printing portions are converted to hydrophilic non-printing portions by photocatalytic action, so the entire surface of the printing plate becomes hydrophilic again.

Thereafter, in the next step of making the printing plate hydrophobic (step A′), an organic compound with a hydrophobic property is applied to the printing plate, so it returns to the initial state at the time of plate making. Thus, the plate 5 can be reused (time a′).

According to the above-described plate-making method and plate-reproducing method, the time to make a printing plate can be shorted because the developing step indispensable for the conventional plate-making step employing a PS plate or CTP plate is omitted. In addition, these methods do not require an alkali developing solution that must be processed as an industrial waste after use, so they are environment-friendly.

(C) Construction of a Printing Press

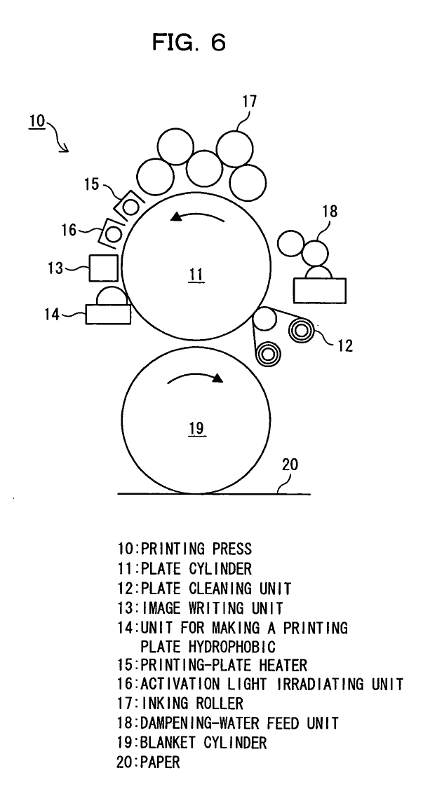

To perform the above-described printing and plate reproduction, a printing press 10 such as the one shown in FIG. 6 is preferred. As shown in the figure, the printing press 10 is made up of a plate cylinder 11, a plate cleaning unit 12, an image writing unit 13, a unit 14 for making a printing plate hydrophobic, a printing-plate heater 15, an activation light irradiating unit (image erasing unit) 16, an inking roller 17, a dampening-water feed unit 18, and a blanket cylinder 19. In addition, the plate 5 is wrapped around the plate cylinder 11.

In the printing press 10, the image history erasure and plate reproduction after printing are performed as follows. Initially, the ink, dampening water, and paper powder on the printing plate are wiped out by the plate cleaning unit 12 in contact with the plate cylinder 11. The plate cleaning unit 12 has a mechanism of winding up an ink-removing cloth tape, but the present invention is not limited to the unit 12. Thereafter, the plate cleaning unit 12 is moved away from the plate cylinder 11. Next, while the printing plate is being heated by the printing-plate heater 15, activation light is irradiated to the entire printing plate to make it hydrophilic with the activation light irradiating unit 16. And an organic compound with a hydrophobic property is supplied to the printing plate to make it hydrophobic by the unit 14.

Next, based on previously prepared image digital data, activation light is irradiated to the printing plate to write non-printing portions by the image writing unit 13. Thereafter, the inking roller 17, dampening-water feed unit 18, and blanket cylinder 19 are brought into contact with the plate cylinder 19, and paper 20 is brought into contact with the blanket cylinder 11. And they are respectively rotated in the directions indicated by arrows to feed dampening water and ink to the printing plate. In this way, printing is performed on paper 20.

With the plate 5 attached to the printing press 10, a sequence of steps, such as cleaning of the printing plate after printing, erasure of printing portions by irradiation of activation light, making the printing plate hydrophobic, plate reproduction, and plate making, can be performed in the printing press 10. This renders it possible to perform printing continuously without stopping the printing press 10 and without interchanging printing plates. In addition, digitalization of the printing step becomes possible, so the management of a printing factory by digital data becomes easier. Since the printing plate can be reproduced for reuse, the cost of the printing plate can be reduced. Particularly, the cost of the printing plate in small-lot printing can be reduced. Furthermore, if the photocatalyst layer 3 is also sensitive to light having wavelengths of less than visible light, inexpensive light sources for emitting light in a visible region can be used and therefore the cost of the writing unit can be reduced.

Although the printing press 10 is constructed such that the plate 5 is wrapped around the plate cylinder 11, the present invention is not limited to this construction. For example, the intervening layer 2 and photocatalyst layer 3 may be provided directly on the surface of the plate cylinder 11. That is, the plate 5 may be formed integrally with the plate cylinder 11.

### (D) OTHER EMBODIMENTS

Next, a description will be given of printing plates constructed in accordance with other embodiments of the present invention.

### Embodiment 1

A silica film (intervening layer 2) consisting of SiO₂ was formed to a thickness of 0.2 μm on a 0.1-mm-thick stainless substrate 1 by RF sputtering, and on that film, a TiO₂ film (photocatalyst layer 3) was formed to a thickness of 0.2 μm by RF sputtering. Also, to enhance the crystallization of the films, the substrate was heated in an oxygen atmosphere for 90 minutes at 550° C. In this way, a plate was made.

The crystallization of the TiO₂ film at that time was observed by X-ray diffraction. As a result, the volume of anatase-type titanium dioxide was larger than that of rutile-type titanium dioxide. Also, an X-ray diffraction spectrum was analyzed and the volume crystallization ratio was 30%.

To make the plate hydrophobic, 1,2-expoxyhexadecane (EPO16 or C₁₄H₂₉COHCH₂) was diluted with an organic solvent (ISOPER L™: Exxon Chemical Japan LTD.) to 0.3 wt % (weight percent). Next, the plate was immersed in this solution. It was dried under the atmosphere of 100° C., and EPO16 was coated on the printing plate. In this state, the printing plate showed a hydrophobic property where the contact angle of water is 98°.

This printing plate was irradiated at room temperature with the ultraviolet light of wavelength 365 nm from a mercury lamp, and the conversion from a hydrophobic property to a hydrophilic property was observed by evaluating the contact angle of water. When the contact angle of water was 5° (the printing plate can be considered to be approximately hydrophilic), the integrated irradiation energy of ultraviolet light was 15 J/cm². The ultraviolet light was irradiated to the printing plate in dependence on image data to obtain hydrophilic and hydrophobic portions. Dampening water was supplied to the printing plate, and then an ink agent was supplied to it. The ink agent remained on the hydrophobic portions. It has also been confirmed that an image can be transferred from the printing plate to paper.

### Comparative Example 1

A printing plate was made by forming a TiO₂ film (photocatalyst layer 3) directly on the stainless substrate of the embodiment 1 without forming a silica film (intervening layer 2). As with the embodiment 1, EPO16 was coated on the plating plate, which was irradiated with ultraviolet light of wavelength 365 nm. The conversion from a hydrophobic property to a hydrophilic property was observed by evaluating the contact angle of water. A large quantity of light energy exceeding tens of joules was irradiated, but no hydrophilic portion was observed. Thus, it has been found that the comparative example 1 cannot function as a printing plate. It has also been found that when there is no silica film, the diffusion of impurity atoms from the stainless substrate occurs and therefore the mechanism of the resolution of an organic compound by light absorption is not functioning properly.

### Embodiment 2

A silica film (intervening layer 2) consisting of SiO₂was formed to a thickness of 0.2 μm on a 0.1-mm-thick stainless substrate 1 by RF sputtering. Next, a TiO₂ film (photocatalyst layer 3) was deposited to a thickness of 0.2 μm on the silica film, by vaporizing organic Ti (Ti(O-i-C₃H₇)₄, etc.) by CVD and then heating the maximum temperature of the substrate to 500° C. to cause Ti gas to perform a resolution reaction. Also, to enhance the crystallization of the films, the substrate was heated in an oxygen atmosphere for 90 minutes at 500° C. In this way, a plate was made.

The crystallization of the TiO₂ film at that time was observed by X-ray diffraction. As a result, the volume crystallization ratio was 70% and the rate of an anatase type in the crystallization was approximately 1. To make the plate hydrophobic, 1,2-expoxyhexadecane (EPO16 or C₁₄H₂₉COHCH₂) was diluted with an organic solvent (ISOPER L™: Exxon Chemical Japan LTD.) to 0.3 wt %. Next, the plate was immersed in this solution. It was dried under the atmosphere of 100° C., and EPO16 was coated on the printing plate. In this state, the printing plate showed a hydrophobic property where the contact angle of water is 96°.

This printing plate was irradiated at room temperature with the ultraviolet light of wavelength 365 nm from a mercury lamp, and the conversion from a hydrophobic property to a hydrophilic property was observed by evaluating the contact angle of water. When the contact angle of water was 5° (the printing plate can be considered to be approximately hydrophilic), the integrated irradiation energy of ultraviolet light was 2 J/cm² Compared to the plate of the embodiment 1 where a TiO₂ film is formed by RF sputtering, the printing plate of the embodiment 2 can be made hydrophilic with light irradiation energy reduced about ten times. It has also been found that high-sensitivity residue removal and writing of an image are possible.

### Embodiment 3

A silica film (intervening layer 2) consisting of SiO₂ was formed to a thickness of 0.2 μm on a 0.1-mm-thick stainless substrate 1 by RF sputtering.

Next, a TiO₂ film (photocatalyst layer 3) was deposited to a thickness of 0.2 μm on the silica film, by vaporizing organic Ti (Ti(O-i-C₃H₇)₄, etc.) by CVD and then heating the maximum temperature of the substrate to 250° C. to cause Ti gas to perform a resolution reaction.

Thereafter, to make the plate hydrophobic, 1,2-expoxydodecane (C₁₀H₂₁COHCH₂) was diluted with an organic solvent (ISOPER L™: Exxon Chemical Japan LTD.) to 0.3 wt %. Next, the plate was immersed in this solution. It was dried under the atmosphere of 100° C. and the diluted 1,2-expoxydodecane was coated on the printing plate. In this state, the printing plate showed a hydrophobic property where the contact angle of water is 105°.

This printing plate was irradiated at room temperature with the ultraviolet light of wavelength 365 nm from a mercury lamp, and the conversion from a hydrophobic property to a hydrophilic property was observed by evaluating the contact angle of water. When the contact angle of water was 5° (the printing plate can be considered to be approximately hydrophilic), the integrated irradiation energy of ultraviolet light was 1 J/cm². It has also been found that high-sensitivity residue removal and writing of an image are possible.

The crystallization of the TiO₂ film at that time was observed by an X-ray diffraction spectrum. As a result, the rate of an anatase type in the crystallization was approximately 1, and diffraction peaks indicating other types of TiO₂ were not observed. Also, diffraction peaks in the <101>, <200>, <004>, <112>, <211>, and <220> plane-directions of an anatase-type crystal were observed together. It has been found that surfaces with these plane-directions are effective to remove residues.

### Embodiment 4

The plate made in the embodiment 3 was irradiated at 100° C., not at room temperature. In this state, the conversion from a hydrophobic property to a hydrophilic property was observed by evaluating the contact angle of water. When the integrated irradiation energy of ultraviolet light was 0.3 J/cm², the printing plate was hydrophilic. From this fact it has been found that if a printing plate is heated as an image is written or residues are removed, processing can be performed in a shorter time with less light irradiation.

### Embodiment 5

The plate made in the embodiment 3 was heated in a range of 400 to 800° C. under an oxygen atmosphere. As a result, when the integrated irradiation energy of ultraviolet light at room temperature with the ultraviolet light of wavelength 365 nm was less than 0.5 J/cm², the printing plate was hydrophilic. From this fact it has been found that if the plate formed by CVD is heated in the above-described temperature range, image writing and image erasure are possible in a shorter time with less light irradiation. If the above-described heating process is performed, it becomes easy to cause the volume rate Rₐ of anatase-type TiO₂ to all of TiO2 in the photocatalyst layer to be between 0.4 and 1.0 and to cause the total volume crystallization ratio of the photocatalyst layer to be 20% or greater. In addition, lattice defects and other defects are reduced and crystal quality becomes higher, so the performance of the photocatalyst layer is enhanced.

### Embodiment 6

A silica film (intervening layer 2) consisting of SiO₂ was formed to a thickness of 0.2 μm on a 0.1-mm-thick stainless substrate 1 by RF sputtering, and on that film, a silica titanium film (intervening layer 2) consisting of SiO₂ and TiO₂ at a volume ratio of 1:1 was formed to a thickness of 0.2 μm. On the silica titanium film, a TiO₂ film (photocatalyst layer 3) was formed to a thickness of 0.2 μm by RF sputtering. Also, to enhance the crystallization of the films, the substrate was heated in an oxygen atmosphere for 90 minutes at 550° C. In this way, a plate was made.

To make the plate hydrophobic, 1,2-expoxyhexadecane (EPO16 or C₁₄H₂₉COHCH₂) was diluted with an organic solvent (ISOPER L™: Exxon Chemical Japan LTD.) to 0.3 wt %. Next, the plate was immersed in this solution. It was dried under the atmosphere of 100° C., and EPO16 was coated on the printing plate. In this state, the printing plate showed a hydrophobic property where the contact angle of water is 97°.

This printing plate was irradiated at room temperature with the ultraviolet light of wavelength 365 nm from a mercury lamp, and the conversion from a hydrophobic property to a hydrophilic property was observed by evaluating the contact angle of water. When the contact angle of water was 5° (the printing plate can be considered to be approximately hydrophilic), the integrated irradiation energy of ultraviolet light was 7 J/cm².

### Embodiment 7

A silica film (intervening layer 2) consisting of SiO₂ was formed to a thickness of 0.2 μm on a 0.1-mm-thick stainless substrate 1 by RF sputtering. Next, a TiO₂ film (photocatalyst layer 3) was deposited to a thickness of 0.2 μm on the silica film, by vaporizing organic Ti (Ti(O-i-C₃H₇)₄, etc.) by CVD and then heating the maximum temperature of the substrate to 500° C. to cause Ti gas to perform a resolution reaction. Furthermore, titanium peroxide sol (TKC-301™: Tayca Corporation solid concentration 1.5 wt %) and ammonia water of concentration 27 wt % were mixed at a weight ratio of 10:1, and the mixed sol was coated on the TiO₂ film. The plate was dried at room temperature, and it was heated for 1 hour at 400° C. The thickness of the photocatalyst layer formed by titanium peroxide sol was 0.2 μm. The crystallization of the TiO₂ film at that time was observed by X-ray diffraction. As a result, the volume crystallization ratio was 50% and the rate of an anatase type in the crystallization was approximately 1.

To make the plate hydrophobic, 1,2-expoxyhexadecane (EPO16 or C₁₄H₂₉COHCH₂) was diluted with an organic solvent (ISOPER L™: Exxon Chemical Japan LTD.) to 0.3 wt %. Next, the plate was immersed in this solution. It was dried under the atmosphere of 100° C., and EPO16 was coated on the printing plate. In this state, the printing plate showed a hydrophobic property where the contact angle of water is 95°.

This printing plate was irradiated at room temperature with light of wavelength 405 nm, and the conversion from a hydrophobic property to a hydrophilic property was observed by evaluating the contact angle of water. When the contact angle of water was 5° (the printing plate can be considered to be approximately hydrophilic), the integrated irradiation energy of ultraviolet light was 20 J/cm².

### Comparative Example 2

In the embodiment 7, without forming a TiO₂ film by CVD, a silica film (intervening layer 2) consisting of SiO₂ was formed to a thickness of 0.2 μm on a 0.1-mm-thick stainless substrate 1 by RF sputtering. Titanium peroxide sol (TKC-301™: Tayca Corporation solid concentration 1.5 wt %) and ammonia water of concentration 27 wt % were mixed at a weight ratio of 10:1, and the mixed sol was coated on the silica film. The plate was dried at room temperature, and it was heated for 1 hour at 400° C. The thickness of the photocatalyst layer formed by titanium peroxide sol was 0.2 μm. The crystallization of the TiO₂ film at that time was observed by X-ray diffraction. As a result, the volume crystallization ratio was 10% and the rate of an anatase type in the crystallization was approximately 0.4.

As with the embodiment 7,1,2-expoxyhexadecane (EPO16 or C₁₄H₂₉COHCH₂) was diluted with an organic solvent (ISOPER L™: Exxon Chemical Japan LTD.) to 0.3 wt %. Next, the plate was immersed in this solution. It was dried under the atmosphere of 100° C., and EPO16 was coated on the printing plate. In this state, the printing plate showed a hydrophobic property where the contact angle of water is 94°.

This printing plate was irradiated at room temperature with light of wavelength 405 nm, and the conversion from a hydrophobic property to a hydrophilic property was observed by evaluating the contact angle of water. When the contact angle of water was 5° (the printing plate can be considered to be approximately hydrophilic), the integrated irradiation energy of ultraviolet light was 50 J/cm².

While the present invention has been described with reference to the preferred embodiments thereof, the invention is not to be limited to the details given herein, but may be modified within the scope of the invention hereinafter claimed.

1. A printing plate comprising:
a photocatalyst layer containing a photocatalyst TiO₂ or a TiO₂ compound in a surface thereof;
wherein a volume rate of an anatase-type crystal in the total crystal component of said photocatalyst TiO₂ or TiO₂ compound is between 0.4 and 1.0, and a total volume crystallization ratio of said photocatalyst is 20% or greater.

2. The printing plate as set forth in claim 1, wherein in X-ray diffraction, said photocatalyst layer shows at least one of the diffraction intensities in the <101>, <200>, <004>, <112>, <211>, and <220> plane-directions of an anatase type.

3. The printing plate as set forth in claim 1, wherein said photocatalyst layer is formed on a metal substrate or a polymer substrate.

4. The printing plate as set forth in claim 3, wherein said substrate is any one of stainless, Ti, and Al plates.

5. The printing plate as set forth in claim 1, wherein said photocatalyst layer is a multilayered film in which the composition or volume crystallization ratios are different.

6. The printing plate as set forth in claim 1, wherein said photocatalyst layer is a gradient film in which the composition or volume crystallization ratio varies continuously in the direction of the film thickness.

7. The printing plate as set forth in claim 1, wherein said photocatalyst TiO₂ or TiO₂ compound is a photocatalyst that responds to light having a wavelength of less than visible light.

8. The printing plate as set forth in claim 3, wherein at least either an intervening layer consisting of SiO₂ or an intervening layer consisting of a silica titania (SiO₂—TiO₂) solid acid catalyst is formed on said substrate, and said photocatalyst layer is formed on said intervening layer.

9. A method of fabricating the printing plate as set forth in claim 1, comprising the step of:
forming said photocatalyst layer by chemical vapor deposition.

10. A method of fabricating the printing plate as set forth in claim 8, comprising the steps of:
forming said intervening layer on said substrate; and
forming said photocatalyst layer on said intervening layer by chemical vapor deposition, after said intervening layer is formed.

11. The method of fabricating the printing plate as set forth in claim 9, wherein after said photocatalyst layer is formed, a heating process is performed at about 400 to 800° C.

12. The method of fabricating the printing plate as set forth in claim 10, wherein after said photocatalyst layer is formed, a heating process is performed at about 400 to 800° C.

13. A method of making a printing plate with a print image by using the printing plate as set forth in claim 1, comprising the steps of:
making a surface of said photocatalyst layer hydrophobic; and
irradiating activation light having energy higher than the bandgap energy of said photocatalyst to at least a portion of the hydrophobic surface of said photocatalyst layer to write an image to the hydrophobic surface of said photocatalyst layer.

14. The method of making the printing plate with a print image by using the printing plate as set forth in claim 13, wherein the surface of said photocatalyst layer is made hydrophobic by supplying a hydrophobic organic compound to the surface of said photocatalyst layer.

15. A method of reproducing a printing plate with a print image by using the printing plate as set forth in claim 1, comprising the steps of:
removing ink adhering to a surface of said photocatalyst layer; and
irradiating activation light having energy higher than the bandgap energy of said photocatalyst to the entire surface of said photocatalyst layer to make the surface of said photocatalyst layer hydrophilic.

16. The method of reproducing the printing plate with a print image by using the printing plate as set forth in claim 15, wherein the surface of said photocatalyst layer is heated at the same time as when activation light is irradiated to the surface of said photocatalyst layer.

17. The method of reproducing the printing plate with a print image by using the printing plate as set forth in claim 16, wherein a temperature at which the surface of said photocatalyst layer is heated is 100° C. or greater.

18. A printing press comprising:
a plate cylinder to which the printing plate as set forth in claim 1 is attached;
a unit for making a surface of a photocatalyst layer of said printing plate hydrophobic;
an image writing unit for irradiating activation light having energy higher than the bandgap energy of said photocatalyst to at least a portion of the hydrophobic surface of said photocatalyst layer to write an image to the hydrophobic surface of said photocatalyst layer;
a cleaning unit for removing ink adhering to the surface of said photocatalyst layer after printing; and
an image erasing unit for erasing said image by irradiating said activation light to the entire surface of said photocatalyst layer after removal of said ink to make the surface of said photocatalyst layer hydrophilic.
